(19) United States
(12) Patent Application Publication
(10) Pub. No.: US 2026/0080240 A1
(43) Pub. Date: Mar. 19, 2026

(54) CURATION OF A TRAINING DATASET OF A MACHINE LEARNING MODEL

(71) Applicant: MICROSOFT TECHNOLOGY LICENSING, LLC., REDMOND, WA (US)

(72) Inventors: ABEDELKADER ASI, SAMMAMISH, WA (US); SHAHAR KEREN, HERMED (IL); OMER LUXEMBOURG, TEL AVIV (IL)

(21) Appl. No.: 18/889,291

(22) Filed: Sep. 18, 2024

(51) Int. Cl. G06N 3/08

(52) U.S. Cl. CPC G06N 3/08

(57) ABSTRACT

The training dataset of a machine learning model is curated to eliminate redundant training samples from a supervised training dataset. The training samples are grouped into classes. An embedding of each training sample is used to search for pairs of training samples within a class having closely-matching embeddings. One training sample of the pair is eliminated. The search uses an approximate nearest neighbor search to find the redundant pairs. A curation process reduces the size of the training dataset to a user-defined removal rate or until the spread of the distribution of the training samples in each class and between classes meets a desired threshold.

### BACKGROUND

Machine learning models are often used to generate natural language text for a variety of applications such as question answering, text summarization, language translation, and transcription. There are numerous machine learning models available having various capabilities, computational requirements, language support, latency and response times, and cost. A machine learning model learns to produce natural language text based on its training dataset which may come from various content sources and domains. From this training dataset, the machine learning model learns to statistically predict which words to use to generate a sentence for a given context. The machine learning model generates the output text based on word frequency, the likelihood that a specific word follows another word, or the likelihood of a specific sentence following another sentence based on the training data.

A key problem arises with training the model. The training dataset is essential to the development of a machine learning model. Extensive efforts have been made to generate large volumes of data to train a machine learning model based on the assumption that the model will produce more accurate results. However, training a machine learning model on a large training dataset presents significant challenges since it requires a longer training time and a large amount of computing resources and computing power.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The training dataset of a machine learning model is curated to eliminate redundant training samples from the training dataset. Embeddings are generated for each training sample and used to search for pairs of training samples that have closely-matching embeddings. A pair of training samples that have closely-matching embeddings is considered a redundant pair. One training sample of the pair is eliminated. The search uses an approximate nearest neighbor search to find the redundant pairs. The number of redundant training samples that are eliminated is set by a user-defined removal rate.

In various examples the training samples are images or audio signals and the training samples are used to train a machine learning model to recognize items in images or audio signals. In some examples the training samples are text or source code and the training samples are used to train a generative machine learning model to complete or extend a given sequence of text or source code. Candidate sequences of text or source code are offered to a user at graphical user interface and when selected by the user are stored in a memory of the computer such as to complete a source code or text document.

For a supervised training dataset, the training samples are labeled using class labels of a plurality of classes. The curation process monitors the spread of the distribution of the training samples of each class and between classes to ensure that the training samples in each class are diverse and that each class is diverse from other classes. A class spread metric and a cross-class proximity metric are computed by the curation process. These metrics are compared to a user-defined threshold to ensure that the curation process maintains a certain level of dissimilarity in the training samples of each class and between the classes. The curation process terminates when one of the metric thresholds or the removal rate is met.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary system for the curation of the training dataset of a machine learning model.

FIG. 2 is a flow diagram illustrating an exemplary method for the curation of the training dataset of a machine learning model.

FIG. 3 is a block diagram illustrating an exemplary operating environment.

### DETAILED DESCRIPTION

### Overview

Aspects of the present disclosure pertain to the curation of a training dataset of a machine learning model. The curation technique minimizes the number of samples in the training dataset while maintaining its value for model training and tuning. The curation technique produces a smaller training dataset that can be used without substantially compromising the machine learning model's performance.

Often the true distribution of the samples in a training dataset are not known and often contain redundant data. The curation technique disclosed herein finds pairs of redundant training samples and eliminates one training sample of the pair. The redundancy is based on closely-matching embeddings for each of the data samples of the pair.

The training samples are grouped into classes, in the case of supervised training data, or in clusters, in the case of unsupervised training data. The curation process monitors the spread of the distribution of each class or cluster and the cross-class proximity of each class or cluster by computing metrics that monitor the effect the removal has on the variability of the training samples in each class or cluster. A class spread metric indicates how similar or different the training samples are in a class or cluster. A cross-class proximity metric indicates how similar or different the training samples in each class are with respect to the other classes or clusters. A class spread threshold indicates that the training samples in a class or cluster have achieved a target spread. A cross-class proximity threshold indicates that each class or cluster has achieved a target difference.

The curation process eliminates redundant pairs of training samples until a removal rate is achieved. The removal rate is a user-defined value that indicates the percentage of the training dataset that is to be removed. Additionally, the curation process terminates when the class spread threshold or the cross-class proximity threshold is met.

Attention now turns to a more detailed description of the components, methods, processes, and system for curating a training dataset of a machine learning model.

### System

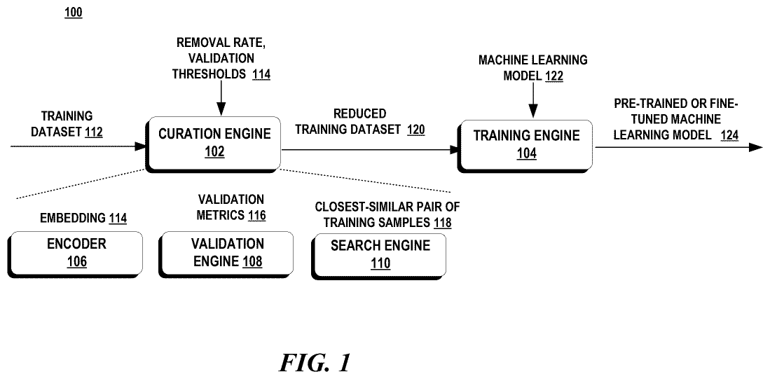

FIG. 1 illustrates a block diagram of an exemplary system 100 for curating the training dataset of a machine learning model. In an aspect, the system 100 includes a curation engine 102 and a training engine 104. The curation engine 102 receives a training dataset 112 a removal rate, and validation thresholds 114. The removal rate is a user input that defines the percentage of the training samples that should be eliminated from the training dataset 112. The validation thresholds are a user input that defines the target spread of the distribution of the training samples in each class and between classes. The training dataset 112 may comprise images. In some cases, the training dataset 112 comprises audio signals. In some cases, the training dataset comprises text documents, in other cases the training dataset comprises source code documents or snippets.

The curation engine 102 reduces the training dataset size by eliminating redundant training samples. The curation engine 102 uses an encoder 106, a validation engine 108, and a search engine 110. The search engine 110 finds pairs of training samples that appear to be redundant and eliminates one of them. Redundancy is based on closely-similar embeddings of the two training samples 118. An embedding is a learned representation for text-based tokens in a training sample where tokens that have a common meaning have a common representation. An embedding may be a vector denoting a position in a multi-dimensional space. The embeddings 114 for each training sample are generated by an encoder 106, such as Word2Vec, Bidirectional Encoder Representations from Transformers (BERT), neural encoder transformer model with attention, and the like.

The validation engine 108 measures the spread of the distribution of the training samples in a class and between classes to track the progress of the curation process. The validation engine 108 uses validation metrics 116 and validation thresholds 114 to track the curation process. The validation thresholds 114 include a class spreading threshold to determine the spread of the training samples within a class and a cross-class proximity threshold to determine the spread of the training samples between each class. The validation thresholds are user-defined values.

The validation engine 108 periodically measures the dispersity of the classes using the validation metrics. When one of the validation thresholds 114 is reached, the curation process stops. The validation thresholds are used to avoid degrading the quality of the training dataset by having too many similar training samples and classes that are closely similar. The class spreading threshold may be 0.9 and the cross-class proximity threshold may be 1.1. These values are chosen to maximize the class spreading distribution and to minimize the cross-class proximity.

The reduced training dataset 120 is then used to pre-train or fine-tune a machine learning model. The training engine 104 may pre-train a machine learning model or fine-tune a pre-trained model 122. Pre-training is where the model is trained on unsupervised data to establish a broad and upper-level understanding of the natural language text. Pre-training is the process where the model's parameters (e.g., embeddings, weights, biases) are learned from unsupervised data. The model learns the parameters through the optimization of a cost function used by the neural network layer of the model. The cost function determines the error loss from the previous epoch which is then backpropagated to the preceding layers of the model. The model's parameters are updated through backpropagation based on the error loss determined by the cost function.

Fine-tuning is where a pre-trained model is trained to learn a specialized task. The parameters of the pre-trained model are optimized for the specialized task by training the model with a fine-tuning dataset. Fine-tuning can alter the parameters of each layer of the model or alter select layers of the model while keeping the parameters of the non-selected layers frozen.

Once the machine learning model 120 has been pre-trained and/or fine-tuned it may be used. In an example, where the machine learning model is trained using images that are labelled according to a class of objects depicted in the image, the trained model may be used to compute a class of object likely to be depicted in a new image. In an example, where the machine learning model 122 has been trained using audio signals labelled according to a class of phoneme, the trained model may be used to compute a phoneme likely to be depicted in a new audio signal.

In an example, where the machine learning model 122 has been trained using sequences of characters, the trained model may be used to compute likely next characters in the sequence.

In an aspect, the machine learning model 122, 124 is deep learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models with attention, recurrent neural networks (RNN) (e.g., long short-term memory (LSTM) network), convolutional neural networks (CNN), and large language models (LLM) are examples of a deep learning model. Examples of a deep learning model include the encoder and generative neural transformer models with attention offered by OpenAI i.e., ChatGPT and Codex models, PaLM, Chinchilla, and Bidirectional Encoder Representations from Transformers (BERT) offered by Google, and LLaMa by Meta.

Deep learning models are trained iteratively, making multiple passes over the training dataset before converging to a minimum. An epoch represents the entire training dataset passed forwards and backwards through the model once. Since the training dataset is very large, it is partitioned into smaller batches. The training is iterative and the entire dataset is passed through the model in multiple iterations. Each training iteration includes forward propagation, loss calculation, backpropagation steps followed by updating the parameters. The training dataset is partitioned into batches with each batch of sequences running through the training process.

### Methods

Attention now turns to a more detailed description of the methods used in the curation of the training dataset of a machine learning model. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

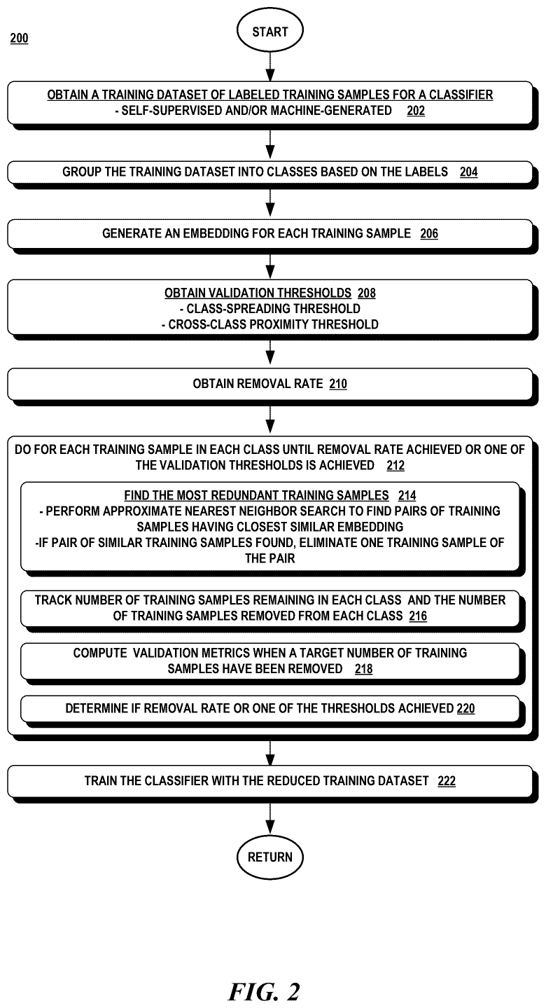

Turning to FIG. 2, there is shown an exemplary method 200 for the curation of a training dataset for a machine learning model. The method is described with respect to the training dataset for a classifier model. However, it should be noted that the technique described herein is not limited to a classifier model and may be applied to generative models as well (sequence-to-sequence models, encoder-decoder models, neural decoder models, large language models, etc.)

Initially, a training dataset of labeled or supervised training samples is obtained (block 202). A supervised dataset contains data samples that are tagged with a label that represents a class, whereas an unsupervised dataset uses unlabeled data. A self-supervised dataset contains data samples that contain labeled and unlabeled data. The training dataset may be machine-generated or obtained from open-source training datasets, such as LLMDataHub offered by GitHub, CommonCrawl, RefinedWeb, and the like.

The training dataset is grouped into classes based on the labels associated with each training sample (block 204). Each class contains training samples with the same label. For each training sample in each class, an embedding is generated for the training sample using the encoder (block 206). The validation thresholds, class spreading threshold and cross-class proximity threshold, are obtained from user input (block 208). The removal rate is also obtained from user input (block 210).

The curation engine proceeds by analyzing each training sample in each class until the removal rate or one of the validation thresholds is achieved (block 212). For each training sample in each class, the search engine finds a pair of training samples that are closely-similar using a distance measure based on the embeddings of each pair (block 214). The distance measure may be cosine similarity. Alternatively, the distance measure may utilize a Euclidean distance or a Manhattan distance. For each pair of closely-matching training samples, one of the pair is removed.

In an aspect, an approximate nearest neighbor search is used to find each pair of closely-similar training samples (block 214). The approximate nearest neighbor search finds a data point that is close to a given data point which is not necessarily the closest one. To find an exact match is costly consuming a considerable amount of computing time and resources. The approximate nearest neighbor search is a trade-off between the time and complexity of a complete search versus a fast search yielding a result that is close enough. An example of an approximate nearest neighbor search is the Approximate Nearest Neighbors Oh Yeah (ANNOY) algorithm. Other search algorithms can be used, such as Facebook AI Similarity Search (FAISS), and Locality-Sensitive Hashing (LSH), which hashes similar items into the same buckets for faster search.

The curation engine tracks the number of training samples eliminated in each class and the number of training samples remaining in each class (block 216). When a threshold number of training samples have been removed for a class, the validation metrics are computed (block 218).

In an aspect, there are two validation metrics that are used to determine the spread of the training samples in each class and the similarity between the classes. There is a class spreading metric and a cross-class proximity metric. The class spreading metric for each class represents the spread of the training samples within the same class. Spread of a class indicates how similar or different the training samples are in a class. The class spreading metric is based on the distance between each of the embeddings in a class. For two training samples in the same class, i and j, the spread between them is represented as S(i, j)=d (eᵢ, eⱼ), where d (eᵢ,

$${e}_{j} ) = \frac{{e}_{i} * {e}_{j}}{‖ {e}_{i} ‖ * ‖ {e}_{j} ‖} ,$$

eᵢ is the embedding of training sample i, and eⱼ is the embedding of training sample j. The class spreading metric for the entire class is calculated by averaging over all the calculated spread distances of each pair of training samples.

The cross-class proximity metric measures the dissimilarity between the training samples of each class. Each class should contain training samples that are dissimilar to the training samples of another class. The distance between the embeddings of a training sample from each class is used to determine the proximity of one class to the other class. For two training samples, i and j, in two different classes, the proximity between the classes is represented as

$$P ( i , j ) = d ( {e}_{i} , {e}_{j} ) , where d ( {e}_{i} , {e}_{j} ) = \frac{{e}_{i} * {e}_{j}}{‖ {e}_{i} ‖ * ‖ {e}_{j} ‖} ,$$

where eᵢ is the embedding of training sample i of a first class, and eⱼ is the embedding of training sample j from a different class. The calculation of cross-class proximity metric is computed by averaging on all cross-class proximity distances of each pair of training samples.

The curation engine continues removing closely-similar training samples until the removal rate is achieved, the class spreading metric meets the class spreading threshold, or the cross-class proximity metric meets the cross-class proximity threshold (block 220). Upon the completion of the curation of the training dataset, the training dataset is used to train a machine learning model (block 222).

The exemplary method shown in FIG. 2 is tailored for the curation of a supervised or labeled training dataset for training a classifier model to predict a class. However, the technique can be easily extended to a generative machine learning model that is not trained on a supervised training dataset. A generative machine learning model may produce an image, text, source code, video, sound, or other outputs based on patterns learned from training data. In this embodiment, embeddings are generated for each training sample of the training dataset and grouped in clusters. Each cluster contains training samples having embeddings close to a centroid of the cluster. A k-means clustering algorithm is used to group the training samples into a cluster. Once the clusters are formed, the curation process described in FIG. 2 proceeds with a cluster acting as a class. Each training sample in each cluster is analyzed to find the most redundant training samples based on embeddings of each training sample. A training sample pair having closely-matching embeddings are selected and one of the training samples of the pair is eliminated. The curation process tracks the remaining samples in each cluster, computes the validation metrics when a target number of training samples have been removed and monitors when the removal rate and validation thresholds have been reached.

In an alternate embodiment, the machine learning model may be a multi-modal model trained on multiple types of data, such as image, text, source code, video, and/or sound. In this embodiment, the training samples are grouped into different classes/clusters based on the type of data and the exemplary method shown in FIG. 2 is configured for the curation of each training dataset.

### Operating Environment

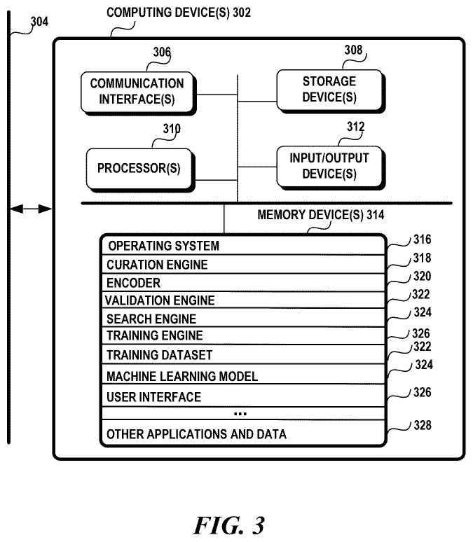

Attention now turns to a discussion of an exemplary operating environment 300. FIG. 3 illustrates an exemplary operating environment 300 having one or more computing devices 302 communicatively coupled to a network 304.

A computing devices 302 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 300 may be configured in a network environment, a distributed environment, a multi-processor environment, or a stand-alone computing device having access to remote or local storage devices.

A computing device 302 may include one or more processors 310, one or more communication interfaces 306, one or more hardware storage devices 308, one or more input/output devices 312, and one or more memory devices 314. A processor 310 may be any commercially available or customized processor and may include dual microprocessors and multi-processor architectures. A communication interface 306 facilitates wired or wireless communications between the computing device 302 and other devices. A hardware storage device 308 may be computer-readable medium that does not contain propagating signals, such as modulated data signals transmitted through a carrier wave. Examples of a hardware storage device 308 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple hardware storage devices 308 in a computing device 302. The input/output devices 312 may include a keyboard, mouse, pen, voice input device, touch input device, display, speakers, printers, etc., and any combination thereof.

A memory device 314 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 314 may also include one or more external storage devices or remotely located storage devices that do not pertain to propagated signals, such as modulated data signals transmitted through a carrier wave.

A memory device 314 may contain instructions, components, and data. A component is a software program that performs a specific function and is otherwise known as a module, program, component, and/or application. The memory device 314 may include an operating system 316, a curation engine 318, an encoder 320, a validation engine 322, a search engine 324, a training engine 326, a training dataset 322, a machine learning model 324, a user interface 326, and other applications and data 328.

A computing device 302 may be communicatively coupled via a network 304. The network 304 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 304 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed pertain to the technical problem of curating a training dataset for a machine learning model. The technical features associated with addressing this problem is the elimination of redundant training samples in the training dataset where the redundancy is based on closely-matching embeddings of a training sample. The technical effect achieved is a reduction in the computational resources and time used by a computing device to train a machine learning model.

### CONCLUSION

The techniques described herein are an improvement over prior solutions. Unlike traditional approaches, such as data augmentation or bias mitigation, which may add data that is similar to the existing training data and risk poor tuning on real-world scenarios, this technique carefully curates massive datasets. Data augmentation is a technique that artificially increases the size of a dataset by modifying existing data or creating new data. By selecting training samples that are sparse yet rich in information, the technique ensures that the training dataset contains challenging, hard-to-distinguish training samples across classes/clusters. This acts as a form of regularization, allowing the model to generalize better and avoid overfitting, leading to more robust performance in diverse applications.

One of ordinary skill in the art understands that the techniques disclosed herein are inherently digital. The operations used to generate embeddings, search for redundant data using the embeddings, and train a machine learning model are inherently digital. The human mind cannot interface directly with a CPU or network interface card, or other processor, or with RAM or other digital storage, to read or write the necessary data and perform the necessary operations disclosed herein.

The embodiments are also presumed to be capable of operating at scale, within tight timing constraints in production environments and in testing labs for production environments as opposed to being mere thought experiments. Hence, the human mind cannot perform the operations described herein in a timely manner and with the accuracy required for these intended uses.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

For example, the technique described herein is applicable for curating the training dataset of a machine learning model for any target task. The techniques are not limited to natural language processing and can be applied to training a machine learning model to perform a computer vision task (i.e., object detection, image classification, pattern recognition) using image embeddings, source code generation using code embeddings, and so forth.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

A system is disclosed, comprising: a processor; and a memory that stores a program that is configured to be executed by the processor. The program comprises instructions to perform actions that: obtain a training dataset for training a machine learning model, wherein the training dataset comprises a plurality of training samples; group the plurality of training samples into a plurality of groups; obtain a removal rate indicating a reduced size of the training samples in the training dataset; generate an embedding for each training sample of each group; curate the training dataset by finding redundant pairs of training samples within a same group having closely-matching embeddings and eliminate one training sample of each pair; and upon the training dataset achieving the removal rate, train the machine learning model with the reduced training dataset.

In an aspect, the program comprises instructions to perform actions that: track the spread of the distribution of the training samples in a group after a threshold number of training samples in the group have been removed. In an aspect, the program comprises instructions to perform actions that: upon the spread of the training samples in the group meeting a threshold, terminate the curation of the training dataset. In an aspect, the program comprises instructions to perform actions that: track the spread of the distribution of the training samples between each group; and terminate the curation of the training dataset when the spread of distribution between the plurality of groups meets a threshold.

In an aspect, the program comprises instructions to perform actions that: compute a distance measure between an embedding of a first training sample in a first group with an embedding of a second training sample in the first group; and when the distance measure is within a prescribed tolerance, identify the first training sample and the second training sample as a redundant pair.

In an aspect, the training samples are images or audio signals and the machine learning model is trained using the training dataset to recognize items depicted in the images or audio signals. In an aspect, the machine learning model is a neural-based classifier, the plurality of training samples comprises a plurality of supervised data, and the plurality of groups comprises a plurality of classes. In an aspect, the training samples are of text or source code, the machine learning model is trained using the training dataset to predict next items in a sequence of text or source code, and the system comprises a user interface to offer the predicted next items to a user for selection and storing in the memory.

A computer-implemented method is disclosed, comprising: accessing a training dataset for training a generative machine learning model, wherein the training dataset comprises a plurality of unsupervised training samples; generating an embedding for each unsupervised training sample; grouping the plurality of unsupervised training samples into a plurality of clusters, wherein a cluster comprises a plurality of unsupervised training samples having embeddings close to a centroid of the cluster; obtaining a removal rate indicating a reduced size of the unsupervised training samples in the training dataset; curating the training dataset by finding redundant pairs of unsupervised training samples within a same cluster having closely-matching embeddings and eliminating one unsupervised training sample of each pair; and upon the training dataset achieving the removal rate, training the generative machine learning model with the reduced training dataset.

In an aspect, the computer-implemented method further comprises: tracking the spread of the distribution of the unsupervised training samples in a select cluster after a threshold number of the unsupervised training samples in the select cluster have been removed.

In an aspect, the computer-implemented method further comprises: upon the spread of the unsupervised training samples in a select cluster meet a threshold, terminate the curation of the unsupervised training dataset. In an aspect, the computer-implemented method further comprises: tracking the spread of the distribution of the unsupervised training samples between each cluster; and terminating the curation of the unsupervised training dataset when the spread of distribution between the plurality of clusters meets a threshold.

In aspect, the computer-implemented method further comprises: computing a distance measure between an embedding of a first training sample in a first cluster with an embedding of a second training sample in the first cluster; and when the distance measure is within a prescribed tolerance, identifying the first training sample and the second training sample as a redundant pair.

In an aspect, generate an embedding for each unsupervised training sample is generated by a neural-based encoder. In an aspect, the machine learning model is a neural transformer model with attention.

A hardware storage device having stored thereon computer executable instructions that are structured to be executable by a processor of a computing device to thereby cause the computing device to perform actions that: form a training dataset for training a classifier machine learning model, wherein the training dataset comprises a plurality of training samples, wherein each training sample is associated with a class; produce an embedding for each supervised training sample; group each of the plurality of supervised training samples into a respective class; obtain a removal rate indicating a reduced size of the supervised training samples in the training dataset; find redundant pairs of the supervised training samples within a same class having closely-matching embeddings and eliminate one supervised training sample of each pair; and upon the training dataset achieving the removal rate, training the classifier machine learning model with the reduced training dataset.

A hardware storage device having stored thereon computer executable instructions that are structured to be executable by a processor of a computing device to thereby cause the computing device to perform actions that: track the spread of the distribution of the supervised training samples in a select class after a threshold number of the supervised training samples in the select class have been removed.

In an aspect, the hardware storage device has stored thereon computer executable instructions that are structured to be executable by a processor of a computing device to thereby cause the computing device to perform actions that: upon the spread of the supervised training samples in a select class meeting a threshold, terminate finding redundant pairs of the supervised training samples within the training dataset.

In an aspect, the hardware storage device has stored thereon computer executable instructions that are structured to be executable by a processor of a computing device to thereby cause the computing device to perform actions that: track the spread of the distribution of the supervised training samples between each class; and terminate finding redundant pairs of the supervised training samples within the training dataset.

In an aspect, the hardware storage device having stored thereon computer executable instructions that are structured to be executable by a processor of a computing device to thereby cause the computing device to perform actions that: determine that two training samples in a same class are a redundant pair based on a distance measure between embeddings of each of the two training samples.

1. A system, comprising:
a processor; and
a memory that stores a program that is configured to be executed by the processor, the program comprises instructions to perform actions that:
obtain a training dataset for training a machine learning model, wherein the training dataset comprises a plurality of training samples;
group the plurality of training samples into a plurality of groups;
obtain a removal rate indicating a reduced size of the training samples in the training dataset;
generate an embedding for each training sample of each group;
curate the training dataset by finding redundant pairs of training samples within a same group having closely-matching embeddings and eliminate one training sample of each pair; and
upon the training dataset achieving the removal rate, train the machine learning model with the reduced training dataset.

2. The system of claim 1, wherein the program comprises instructions to perform actions that:
track the spread of the distribution of the training samples in a group after a threshold number of training samples in the group have been removed.

3. The system of claim 2, wherein the program comprises instructions to perform actions that:
upon the spread of the training samples in the group meeting a threshold, terminate the curation of the training dataset.

4. The system of claim 1, wherein the program comprises instructions to perform actions that:
track the spread of the distribution of the training samples between each group; and
terminate the curation of the training dataset when the spread of distribution between the plurality of groups meets a threshold.

5. The system of claim 1, wherein the program comprises instructions to perform actions that:
compute a distance measure between an embedding of a first training sample in a first group with an embedding of a second training sample in the first group; and
when the distance measure is within a prescribed tolerance, identify the first training sample and the second training sample as a redundant pair.

6. The system of claim 1, wherein the training samples are images or audio signals and wherein the machine learning model is trained using the training dataset to recognize items depicted in the images or audio signals.

7. The system of claim 1, wherein the machine learning model is a neural-based classifier, wherein the plurality of training samples comprises a plurality of supervised data, and wherein the plurality of groups comprises a plurality of classes.

8. The system of claim 1, wherein the training samples are of text or source code and wherein the machine learning model is trained using the training dataset to predict next items in a sequence of text or source code, and wherein the system comprises a user interface to offer the predicted next items to a user for selection and storing in the memory.

9. A computer-implemented method, comprising:
accessing a training dataset for training a generative machine learning model, wherein the training dataset comprises a plurality of unsupervised training samples;
generating an embedding for each unsupervised training sample;
grouping the plurality of unsupervised training samples into a plurality of clusters, wherein a cluster comprises a plurality of unsupervised training samples having embeddings close to a centroid of the cluster;
obtaining a removal rate indicating a reduced size of the unsupervised training samples in the training dataset;
curating the training dataset by finding redundant pairs of unsupervised training samples within a same cluster having closely-matching embeddings and eliminating one unsupervised training sample of each pair; and
upon the training dataset achieving the removal rate, training the generative machine learning model with the reduced training dataset.

10. The computer-implemented method of claim 9, further comprising:
tracking the spread of the distribution of the unsupervised training samples in a select cluster after a threshold number of the unsupervised training samples in the select cluster have been removed.

11. The computer-implemented method of claim 9, further comprising:
upon the spread of the unsupervised training samples in a select cluster meet a threshold, terminate the curation of the unsupervised training dataset.

12. The computer-implemented method of claim 9, further comprising:
tracking the spread of the distribution of the unsupervised training samples between each cluster; and
terminating the curation of the unsupervised training dataset when the spread of distribution between the plurality of clusters meets a threshold.

13. The computer-implemented method of claim 9, further comprising:
computing a distance measure between an embedding of a first training sample in a first cluster with an embedding of a second training sample in the first cluster; and
when the distance measure is within a prescribed tolerance, identifying the first training sample and the second training sample as a redundant pair.

14. The computer-implemented method of claim 9, wherein generate an embedding for each unsupervised training sample is generated by a neural-based encoder.

15. The computer-implemented method of claim 9, wherein the machine learning model is a neural transformer model with attention.

16. A hardware storage device having stored thereon computer executable instructions that are structured to be executable by a processor of a computing device to thereby cause the computing device to perform actions that:
form a training dataset for training a classifier machine learning model, wherein the training dataset comprises a plurality of training samples, wherein each training sample is associated with a class;
produce an embedding for each supervised training sample;
group each of the plurality of supervised training samples into a respective class;
obtain a removal rate indicating a reduced size of the supervised training samples in the training dataset;
find redundant pairs of the supervised training samples within a same class having closely-matching embeddings and eliminate one supervised training sample of each pair; and
upon the training dataset achieving the removal rate, training the classifier machine learning model with the reduced training dataset.

17. The hardware storage device of claim 16 having stored thereon computer executable instructions that are structured to be executable by a processor of a computing device to thereby cause the computing device to perform actions that:
track the spread of the distribution of the supervised training samples in a select class after a threshold number of the supervised training samples in the select class have been removed.

18. The hardware storage device of claim 16 having stored thereon computer executable instructions that are structured to be executable by a processor of a computing device to thereby cause the computing device to perform actions that:
upon the spread of the supervised training samples in a select class meeting a threshold, terminate finding redundant pairs of the supervised training samples within the training dataset.

19. The hardware storage device of claim 16 having stored thereon computer executable instructions that are structured to be executable by a processor of a computing device to thereby cause the computing device to perform actions that:
track the spread of the distribution of the supervised training samples between each class; and
terminate finding redundant pairs of the supervised training samples within the training dataset.

20. The hardware storage device of claim 16 having stored thereon computer executable instructions that are structured to be executable by a processor of a computing device to thereby cause the computing device to perform actions that:
determine that two training samples in a same class are a redundant pair based on a distance measure between embeddings of each of the two training samples.
